(19) United States
(12) Patent Application Publication
(10) Pub. No.: US 2013/0031286 A1
(43) Pub. Date: Jan. 31, 2013

(54) ACTIVE INFORMATION SHARING SYSTEM AND DEVICE THEREOF

(71) Applicants: CHENG-HSUI WU, HSINCHU COUNTY (TW); CHENG-HUNG HUANG, HSINCHU CITY (TW); HUNG-I LIN, HSINCHU COUNTY (TW)

(72) Inventors: CHENG-HSUI WU, HSINCHU COUNTY (TW); CHENG-HUNG HUANG, HSINCHU CITY (TW); HUNG-I LIN, HSINCHU COUNTY (TW)

(73) Assignee: TENX TECHNOLOGY INC., NEW TAIPEI CITY (TW)

(21) Appl. No.: 13/560,209

(22) Filed: Jul. 27, 2012

(30) Foreign Application Priority Data
Jul. 29, 2011 (TW) 100126964

(51) Int. Cl. G06F 13/00

(52) U.S. Cl. 710/110

(57) ABSTRACT

An active information sharing system having a master device and a slave device is disclosed. When the master device is connected to a first host of an administrator, the master device automatically links to a server through a first network module of the first host, for sharing at least an information from the administrator. The master device correspondingly sets a first parameter to the slave device. When the slave device is connected to a second host of an invited client, the slave device automatically links to the server through a second network module of the second host according to the first parameter, for acquiring the information shared from the administrator.

### BACKGROUND

1. Technical Field

The present disclosure relates to an information sharing system, and in particular, to an active information sharing system, a method thereof, and a device thereof.

2. Description of Related Art

Presently, most of the web sites have various information (such as the contents of documents and media) and services (such as interactive services), but those information and services are provided to the users passively. That is, the user needs to connect to the web site in advance for acquiring the information and services provided by the web site.

In addition, there are many web providers who provide blogs, community sites, or dating sites for allowing people to share information or interact with another one person. However, the relations between users still need to be built by the manners which lack for actual senses, such as numerous of random searches and email comparisons. In other words, the kinds of information sharing cannot build the relation between the users without the information of the target users.

One-way information sharing may also be achieved by physical manners, such as advertisements, coupons, or invitation mails. No matter whether the user uses or receives them or not, these kinds of information sharing manners may provide actual and precise contacts manners, but the disadvantages are that the contents thereof cannot have the multimedia contents and the real-time interactions provided by the web site.

Similarly, two-way information sharing may also be implemented by physical manners, such as business card or physical item exchanging. Business card exchanging may build actual relations between people, and physical item exchanging may build much more precise relations between the two sides of persons. However, these kinds of information sharing manners also lack for actual real-time reactions, and cannot provide abundant personal information to the receiving side.

The present universal serial bus (USB) products are independent devices focusing at some special functions, and thus they can only provide single and specific function without the mechanism for establishing the interaction manners between devices. Therefore, the present USB devices do not have the capability of network interacting or integrating the network information services.

### SUMMARY

An embodiment of the present disclosure provides an active information sharing system which has an administrator and an invited client. The administrator comprises a master device and a first host, and the invited client comprises a slave device and the second host. The master device is used to connect to a first host of an administrator, and correspondingly set a first parameter of the slave device. When the master device is connected to the first host, the master device automatically links to a server through a first network module of the first host, and shares at least a first information from the administrator. When the slave device is connected to second host, the slave device automatically links to the server through a second network module of the second host according to the first parameter, for acquiring the first information.

In one embodiment of the present disclosure, the first parameter includes a server address and a client authority. The slave device automatically links to the server through the second network module of the second host according to the server address, and acquires the first information according to the client authority.

In another one embodiment of the present disclosure, an invited client shares at least a second information thereof through the slave device, and thus the master device acquires the second information through the server.

An embodiment of the present disclosure provides a master device including an active device and an extended logic unit. When the master device is connected to the first host, the active device automatically links to the server through the first network module of the first host, and shares at least a first information from the administrator. When the master device and the slave device are connected with each other, the extended logic unit is used for correspondingly setting the first parameter of the slave device.

In one embodiment of the present disclosure, the active device includes a control unit, a logic unit, a storage unit, and an emulation unit. The control unit connects to the first network module of the first host, and generates a control command. The logic unit connects to the control unit, receives the control command, and generates an operation command. The storage unit connects to the logic unit, and receives the operation command to execute a storage operation. The emulation unit allows the master device to automatically link to the server by executing an application program.

In another one embodiment of the present disclosure, the master device connects to the first host through a bus interface, and the administrator sets the second parameter of the master device through the first host. The second parameter includes a server address and an administrator authority, such that the master device automatically links to the server through the first network module of the first host, and is able to manage the server.

An embodiment of the present disclosure provides a slave device including an active device and a connection managing unit. The connection managing unit manages the connection between the slave device and the master device, and sets the first parameter of the slave device through the master device. The connection managing unit further manages the connection between the slave device and the second host. At the moment, the active device of the slave device automatically links to the server through the second network module of the second host according to the first parameter, for acquiring at least a first information shared from the administrator.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a block diagram of an active information sharing system according to an embodiment of the present disclosure;

FIG. 2 shows a block diagram of an active information sharing system according to another one embodiment of the present disclosure;

FIG. 3 shows a block diagram of a master device according to an embodiment of the present disclosure;

FIG. 4 shows a block diagram of a slave device according to an embodiment of the present disclosure;

FIG. 5 shows a schematic diagram about the master device correspondingly sets the first parameter of the slave device according to an embodiment of the present disclosure;

FIG. 6 shows a schematic diagram about the master device correspondingly sets the first parameter of the slave device according to another one embodiment of the present disclosure;

FIG. 7 shows a schematic diagram about the master device correspondingly sets the first parameter of the slave device according to another one embodiment of the present disclosure;

FIG. 8 shows a block diagram of an active information sharing system according to another one embodiment of the present disclosure;

FIG. 9 shows a flow chart that the administrator shares the information through the master device according to an embodiment of the present disclosure;

FIG. 10 shows a flow chart that the invited client shares the information through the slave device according to an embodiment of the present disclosure; and

FIG. 11 shows a flow chart that the administrator and the invited client share the information with each other through a peer-to-peer network linking manner according to an embodiment of the present disclosure.

### DESCRIPTION OF EXEMPLARY EMBODIMENTS

### Embodiment of Active Information Sharing System

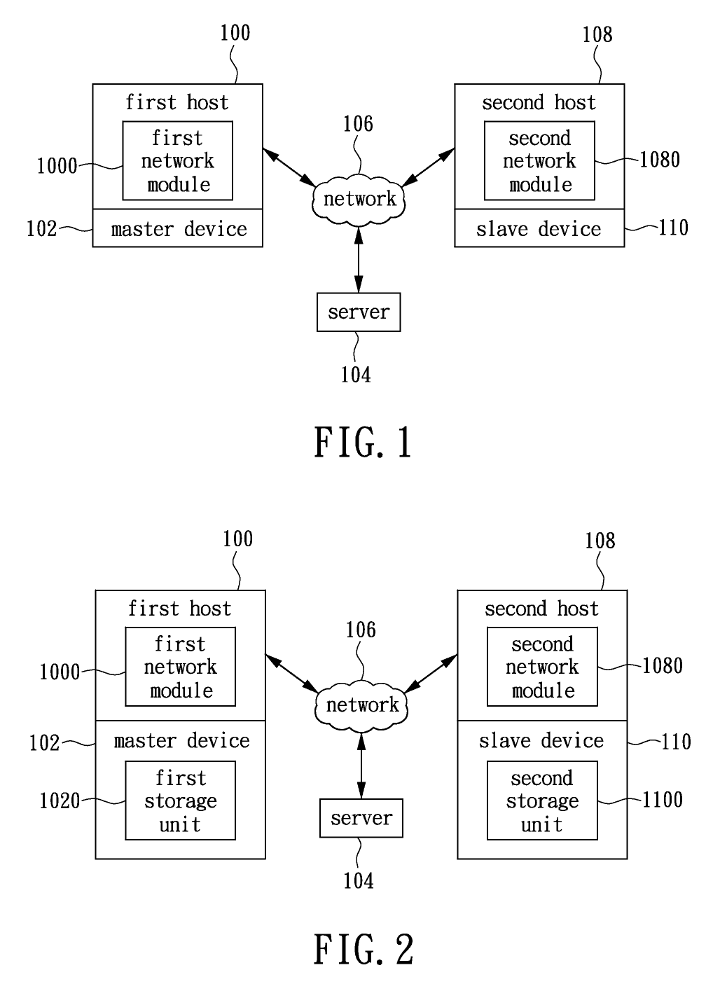

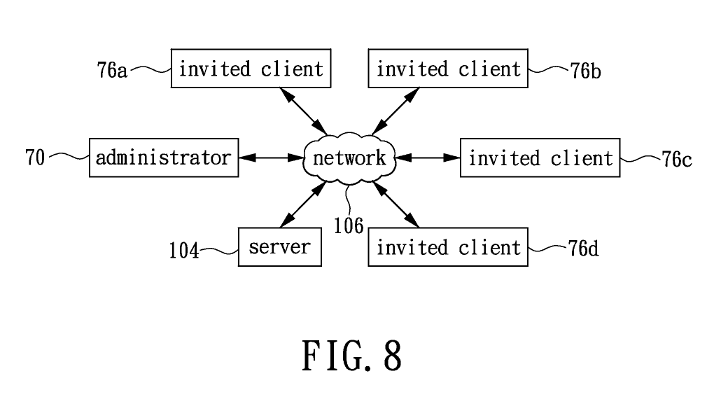

Please refer to FIG. 1 which shows a block diagram of an active information sharing system according to an embodiment of the present disclosure. The active information sharing system includes a master device 102 and a slave device 110. The master device 102 is connected to a first host 100 of the user who actively shares information, the user who actively shares information is called as an administrator 70 (please refer to FIG. 8), and thus the administrator 70 comprises the master device 102 and the first host 100. The slave device 110 is connected to a second host 108 of the user who receives the information from the administrator 70, the user receiving the information from the administrator 70 may also be called as an invited client 76 (please refer to FIG. 8, wherein any one of the invited clients 76a to 76d may be the counterpart of the invited client 76 in the embodiment), and thus the invited client 76 comprises the slave device 110 and the second host 108.

The first host 100 and the second host 108 both are the electrical devices with the internet access abilities. For example, the first host 100 and the second host 108 respectively have a first network module 1000 and a second network module 1080. In addition, the first network module 1000 and the second network module 1080 can be externally connected network modules.

The first network module 1000 of the first host 100 links to the server 104 through the network 106, and the second network module 1080 of the second host 108 links to the server 104 through the network 106. The first network module 1000 and the second network module 1080 can be network interface cards, wireless local area network (WLAN) cards, or third-generation (3G) mobile communication cards, etc.

The master device 102 communicates with the first host 100 through a bus interface. Similarly, the slave device 110 communicates with the second host 108 through a bus interface. The bus interface can be a universal serial bus (USB) interface, a peripheral component interconnect (PCI) express interface, or a serial advanced technology attachment (SATA) interface, etc.

When the master device 102 connects to the first host 100, the master device 102 automatically links to the server 104 through the first network module 1000 of the first host 100, for sharing at least a first information from the administrator 70. The slave device 110 indicates the master device 102 to set the first parameter of the slave device 110. Thus, when the slave device 110 is connected to the second host 108, the slave device 110 automatically links to the server 104 through the second network module 1080 of the second host 108 according to the first parameter, for receiving the first information shared from the administrator 70.

Simply speaking, the administrator 70 sets the first parameter of the slave device 110, and the administrator 70 shares the set slave device 110 to the invited client 76 by a physical manner. Thus, when the invited client 76 connects the slave device 110 to the second host 108, the invited client 76 automatically acquires the first information shared from the administrator 70 through the internet access.

In addition, the master device 102 also has a second parameter, and the administrator 70 may set the second parameter of the master device 102 through the first host 100. In addition, the second parameter of the master device 102 is set in advance by the manufacturer of the master device 102. The second parameter of the master device 102 may include a server address of the server 104 and an administrator authority. When the master device 102 is connected to the first host 100, the master device 102 automatically links to the server 104 assigned with the second parameter through the first network module 1000, and manages the server 104.

For example, the server address of the server 104 set by the administrator 70 is a community web. When the administrator 70 sets the second parameter of the master device 102 through the first host 100, the server address of the server 104 in the second parameter of the master device 102 can be set as the web address of the community site. It's worth noting that the server address of the server 104 in the present disclosure is not limited thereby.

The first parameter of the slave device 110 includes a server address of the server 104 and a client authority of the invited client 76. The server address in the first parameter of the slave device 110 is the same as the server address in the second parameter of the master device 102, thus it is not repeatedly described. The client authority is used for assigning the authority of the slave device 110 for acquiring the information shared from the administrator 70, that is, the administrator 70 may be able to set the client authority of the invited client 76 for acquiring the information shared from the administrator 70.

For example, the information at the server 104 shared from the administrator 70 includes five data files, and the five data files include one image file and four video files. When the client authority in the first parameter of the slave device 110 is set to only allowing the acquiring of the image file, the invited client 76 can only access or open the image file at the server 104.

In addition to acquiring the information shared from the administrator 70 through the slave device 110, the invited client 76 shares the information thereof to the server 104 through the slave device 110, such that the administrator 70 can acquire the information shared from the invited client 76 through the master device 102. The information shared from the administrator 70 and the information shared from the invited client 76 can be image files, video files, or data files, etc. By using the master device 102 and the slave device 110, in addition to share information from the administrator 70 to the invited client 76 in one-way direction, the administrator 70 and the invited client 76 can interactively share the information with each other in two- way directions.

The active information sharing system provided by the present disclosure may be used for replacing conventional information linking tools, and the possible applications of the active information sharing system are described as follows. However, the following descriptions are not used for limiting the scope of the present disclosure.

The active information sharing system may allow the administrator 70 to share the business card information of the administrator 70, that is, the administrator 70 may make the slave device 110 become a USB business card. The active information sharing system may also allow the administrator 70 and the invited client 76 to communicate with each other in the real-time and peer-to-peer network linking manner, and allows the administrator 70 to set the personal information to be shared, such as the community web linking, blogs, or company products. Firstly, the administrator 70 sets the first parameter to the slave device 110 through the master device 102. Then, the administrator 70 gives the slave device 110 to the invited client 76 as a business card. After that, the invited client 76 connects the slave device 110 to the second host 108 (such as a personal computer or a smart phone), and the slave device 110 automatically links to the server 104 through the second network module 1080, for allowing the invited client 76 to be able to interact with the administrator 70, and directly acquires the information shared from the administrator 70.

The slave device 110 of the active information sharing system can be a USB restaurant coupon, and the administrator 70 and the invited client 76 respectively can be a restaurant businessman and a consumer. The administrator 70 distributes the slave device 110 to the invited client 76, and the invited client 76 automatically links to the server 104 through the slave device 110. The server 104 has a coupon information shared from the administrator 70 or an exclusive service region opened by the administrator 70 to the invited client 76, for allowing the invited client 76 to acquire the discount, do online reservation, or feedback the opinion through the server 104.

The slave device 110 of the active information sharing system can be a USB star fan member card, and the administrator 70 and the invited client 76 respectively can be a star and a fan. The administrator 70 distributes the slave device 110 to the invited client 76, and the invited client 76 automatically links to the server 104 through the slave device 110. The server 104 has the information of the star shared from the administrator 70 or the exclusive fan region and the message board opened by the administrator 70 to the invited client 76, for allowing the invited client 76 to receive the information shared from the star, or communicate with the star through the server 104 in a real-time and peer-to-peer network linking manner.

### Another Embodiment of Active Information Sharing System

Please refer to FIG. 2 which shows a block diagram of an active information sharing system according to another one embodiment of the present disclosure. Compared to the embodiment in FIG. 1, the master device 102 in FIG. 2 further includes a first storage unit 1020, and the slave device 110 in FIG. 2 further has a second storage unit 1100. The server 104 in the embodiment stores the linking information of the administrator 70 (depicted in FIG. 8), such that the invited client 76 (shown in FIG. 8) can link to the administrator 70 according to the linking information. That is, according to the linking information, the invited client 76 links to the administrator 70 in a peer-to-peer network linking manner through the network 106, and is able to perform information sharing or real-time interaction. The linking information may be an Internet protocol (IP) address or an identity (ID), but the present disclosure is not limited thereby.

The administrator 70 uses the master device 102 for storing the linking information of the first host 100 in the server 104. In other words, when the master device 102 is connected to the first host 100, the first host 100 is able to link to the server 104, and store the linking information of the first host 100 in the server 104.

The invited client 76 uses the slave device 110 for reading the linking information stored in the server 104, and directly links to the address assigned by the linking information. In other words, when the slave device 110 is connected to the second host 108, the second host 108 automatically links to the server 104, for reading the linking information stored in the server 104. After that, according to the linking information, the second host 108 directly links to the assigned address (which is the address of the first host 100 of the administrator 70 in this embodiment).

Thus, the invited client 76 is able to link to the administrator 70 through the mentioned manners, and to share information with each other or interactive with each other in a real-time manner. The shared information is the information stored in the master device 102 or the slave device 110, that is, the administrator 70 store at least a first information which is going to be shared in the first storage unit 1020 of the master device 102, and the invited client 76 stores at least a second information which is going to be shared in the second storage unit 1100 of the slave device 110.

On the basis of the above, after the administrator 70 and the invited client 76 are linked to each other in the peer-to-peer network linking manner, the invited client 76 acquires the first information of the administrator 70 stored in the master device 102 according to the client authority of the first parameter, and the administrator 70 also acquires the information of the invited client 76 stored in the slave device 110. Therefore, in addition to information sharing, the administrator 70 and the invited client 76 also protect and control the sharing restrictions of the information. That is, according to the linking relations in this embodiment, the invited client 76 cannot directly acquire the information stored in the first host 100, and the administrator 70 cannot directly acquire the information stored in the second host 108. It's worth noting that the aforementioned information sharing manners and the information storing locations do not limit the scope of the present disclosure.

In addition, the administrator 70 and the invited client 76 communicate with each other in a real-time and peer-to-peer network linking manner. The real-time communications include real-time message transmission, real-time talking, and video phone call, etc.

### Embodiment of Master Device

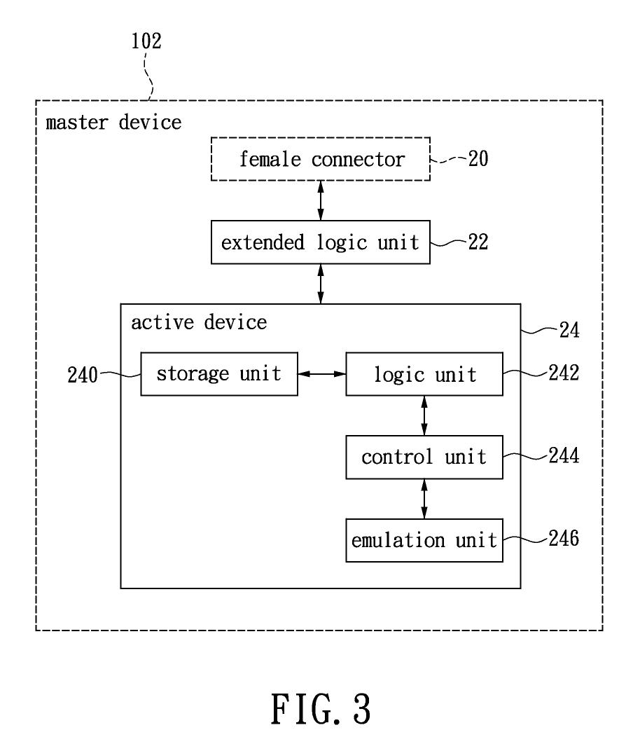

Please refer to FIGS. 1 and 3. FIG. 3 shows a block diagram of a master device according to an embodiment of the present disclosure. The master device 102 includes an extended logic unit 22 and an active device 24, and further includes a female connector 20. The master device 102 of the active information sharing system in FIG. 1 can be implemented as the master device 102 in FIG. 3, but the scope of the present disclosure is not limited thereby.

The master device 102 is connected to the first host 100 of the administrator 70 through the active device 24, and the first host 100 sets a second parameter of the master device 102. The second parameter includes the server address of the server 104 and the administrator authority. The active device 24 automatically links to the server 104 through the first network module 1000 of the first host 100 according to the second parameter, such that the administrator 70 shares at least a first information to the server 104 through the master device 102. The extended logic unit 22 is for correspondingly setting the first parameter of the slave device 110.

The active device 24 may include a storage unit 240, a logic unit 242, a control unit 244, and an emulation unit 246. The emulation unit 246 is connected to the control unit 244, the control unit 244 is connected to the logic unit 242, and the logic unit 242 is connected to the storage unit 240.

The control unit 244 further connects to the first network module 1000 of the first host 100 of the administrator 70, and generates a control command. The logic unit 242 receives the control command and generating an operation command. The storage unit 240 receives the operation command, and operates the storage operation accordingly, such as storing the information shared from the administrator 70, the information shared from the invited client 76, or other information (for example, the second parameter of the master device 102 or the application programs), etc. The emulation unit 246 indicates the master device 102 to automatically link to the server 104 by executing the application program. On the basis of the above, by using the active device 24 of the master device 102, the administrator 70 connects to the first host 100, such that the first host 100 of the administrator 70 automatically links to the server 104, and thus shares at least a first information from the administrator 70 to the server 104.

In addition, the master device 102 connects to the slave device 110 by using the female connector 20, and correspondingly sets the first parameter of the slave device 110 through the extended logic unit 22. By disposing the female connector 20 and the extended logic unit 22 at the master device 102, the connections between the master device 102 and the slave device 110 does not need to use the host integrated circuit of the USB.

The female connector 20 may be an A type female connector of the USB, and the slave device 110 may have an A type male connector of the USB. Thus, when the master device 102 and the slave device 110 are connected to each other through the A type female connector and the A type male connector of the USB, the master device 102 and the slave device 110 can communicate with each other by using USB interface. It's worth noting that the implementations as the female connector 20 and the USB interface do not be used for limiting the scope of the present disclosure.

### Embodiment of Slave Device

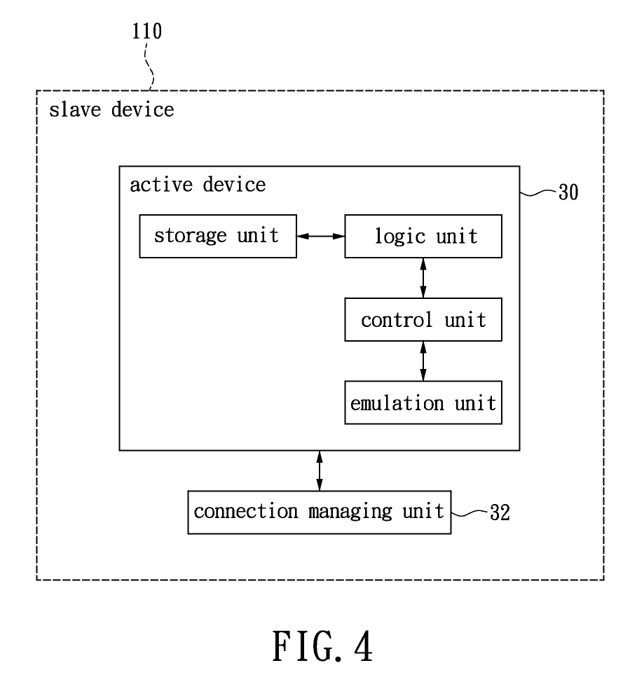

Please refer to FIGS. 1 and 4. FIG. 4 shows a block diagram of a slave device according to an embodiment of the present disclosure. The slave device 110 includes a connection managing unit 32 and an active device 30. The slave device 110 of the active information sharing system in FIG. 1 can be implemented by the slave device 110 in FIG. 4, but the scope of the present disclosure is not limited thereby.

The connection managing unit 32 manages the connection between the slave device 110 and the master device 102. At the moment, the master device 102 correspondingly sets the first parameter of the slave device 110. The first parameter includes the server address of the server 104 and the client authority. The connection managing unit 32 also manages the connection between the slave device 110 and the second host 108, such that the active device 30 is able to automatically link to the server 104 through the second network module 1080 of the second host 108 of the invited client 76 according to the first parameter. Thus, the invited client 76 acquires the information shared from the administrator 70 from the server 104.

The active device 30 in FIG. 4 and the active device 24 in FIG. 3 have the same functionalities, and thus the repeated description is not described again.

### Embodiment for Setting First Parameter of Slave Device by Using Master Device

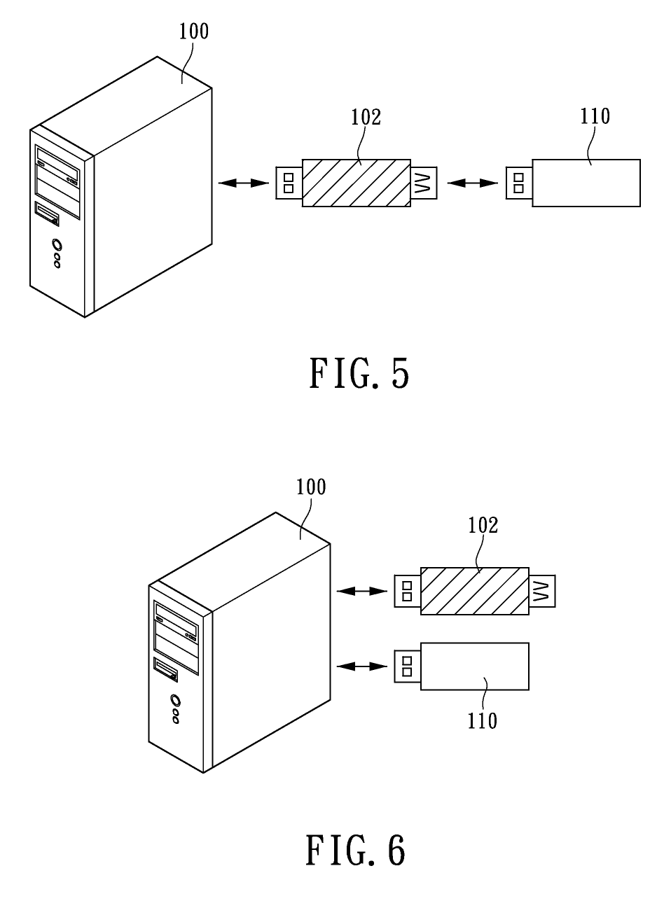

Please refer to FIG. 5 which shows a schematic diagram of the master device for setting the first parameter of the slave device according to an embodiment of the present disclosure. The male connector of the master device 102 is connected to the first host 100 of the administrator 70, and the female connector 20 of the master device 102 is connected to the male connector of the slave device 110, such that the master device 102 is able to correspondingly set the first parameter of the slave device 110.

### Another Embodiment for Setting First Parameter of Slave Device by Using Master Device

Please refer to FIG. 6 which shows a schematic diagram of the master device for setting the first parameter of the slave device according to another one embodiment of the present disclosure. The slave device 110 in FIG. 6 is directly connected to the first host 100, such that the master device 102 needs to correspondingly set the first parameter of the slave device 110 through the first host 100. It's worth noting that the master device 102 in FIG. 6 selectively does not have the female connector 20 (please refer to FIG. 3).

### Another Embodiment for Setting First Parameter of Slave Device by Using Master Device

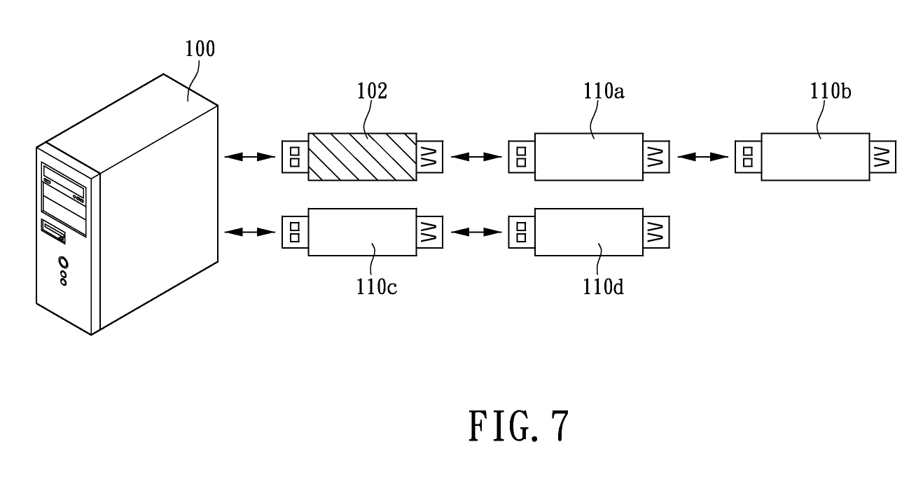

Please refer to FIG. 7 which shows a schematic diagram of the master device for setting the first parameter of the slave device according to another one embodiment of the present disclosure. The master device 102 in FIG. 7 correspondingly sets the first parameters of the slave devices 110a and 110b. The slave devices 110a and 110b are connected serially to each other, and one slave device 110a is connected to the master device 102. In addition, the master device 102 in FIG. 7 also correspondingly set the first parameters of the slave devices 110c and 110d. The slave devices 110c and 110d are connected serially with each other, and the slave device 110c connects to the first host 100.

### Another Embodiment of Active Information Sharing System

Please refer to FIG. 8 which shows a block diagram of an active information sharing system according to another embodiment of the present disclosure. The differences between FIGS. 1 and 8 are that the active information sharing system in FIG. 8 includes several invited clients 76a through 76d. The invited clients 76a through 76d automatically links to the server 104 through the slave devices 110, for acquiring at least a first information shared from the administrator 70. The invited clients 76a through 76d also share informations thereof to the server 104, such that the administrator 70 is able to acquire the information shared from the invited clients 76a through 76d.

For example, the invited clients 76a through 76d can be the members of the administrator 70. By using the active information sharing system, the information (such as preferential information and activity information) shared from the administrator 70 is stored in the server 104, and the invited clients 76a through 76d acquire the information shared from the administrator 70 according to the client authorities. The invited clients 76a through 76d provide and store shared informations (such as member data update and client opinions) thereof to the server 104 through the network 106, such that the administrator 70 acquires the informations shared from the invited clients 76a to 76d.

### Embodiment of Active Information Sharing Method

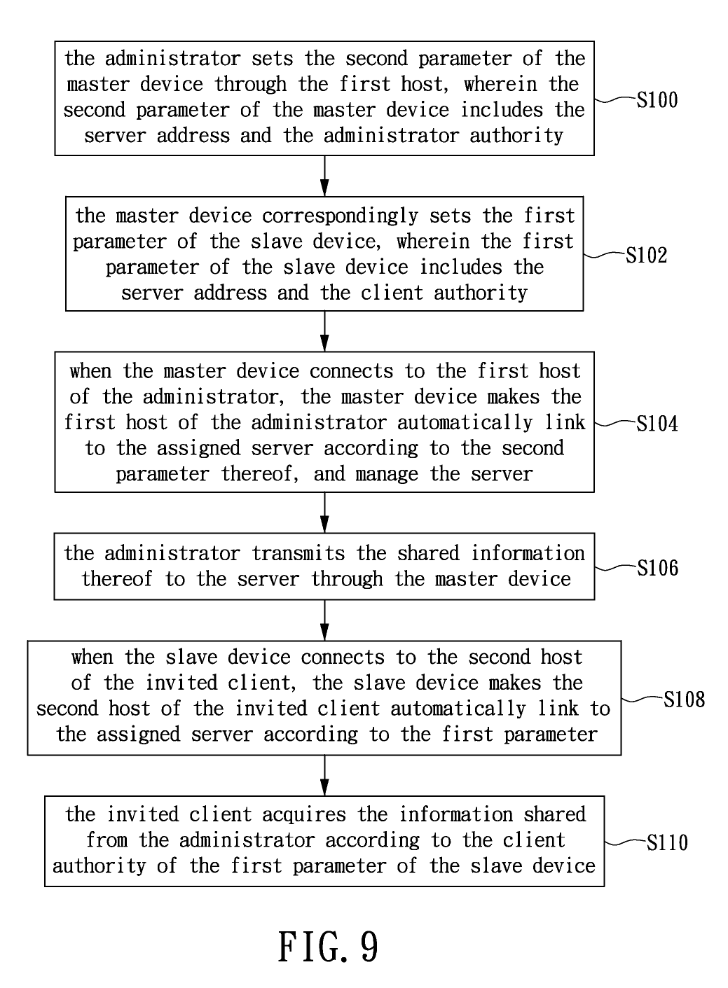

Please refer to FIGS. 1 and 9. FIG. 9 shows a flow chart that the administrator shares the information from the administrator through the master device according to an embodiment of the present disclosure. At step S100, the administrator 70 sets the second parameter of the master device 102 through the first host 100. The second parameter includes the server address of the server 104 and the administrator authority. After that, at step S102, the master device 102 correspondingly sets the first parameter of the slave device 110. The first parameter includes the server address of the server 104 and the client authority.

The manner of the master device 102 for setting the first parameter of the slave device 110 is described as the aforementioned descriptions. The female connector 20 (depicted in FIG. 3) of the master device 102 connects the master device 100 to the slave device 110, in order to correspondingly set the first parameter. Alternatively, a USB host control chip of the first host 100 of the administrator 70 is used to connect the master device 102 to the slave device 110, in order to set the first parameter. In addition, the master device 102 also sets the first parameter of the slave device 110 of the second host 108 disposed at the invited client 76. The mentioned manners for setting the first parameter do not limit the scope of the present disclosure.

At step S104, when the master device 102 connects to the first host 100 of the administrator 70, the master device 102 makes the first host 100 automatically link to the server 104 according to the second parameter, and manage the server 104. Then, at step S106, the administrator 70 transmits the shared information to the server 104 through the master device 102. After that, at step S108, when the slave device 110 is connected to the second host 108 of the invited client 76, the slave device 110 make the second host 108 automatically link to the server 104 according to the first parameter. At last, at step S110, the invited client 76 acquires the information shared from the administrator 70 according to the client authority of the first parameter of the slave device 110. On the basis of the above, the master device 102 shares the information shared from the administrator 70 to the invited client 76.

### Another Embodiment of Active Information Sharing Method

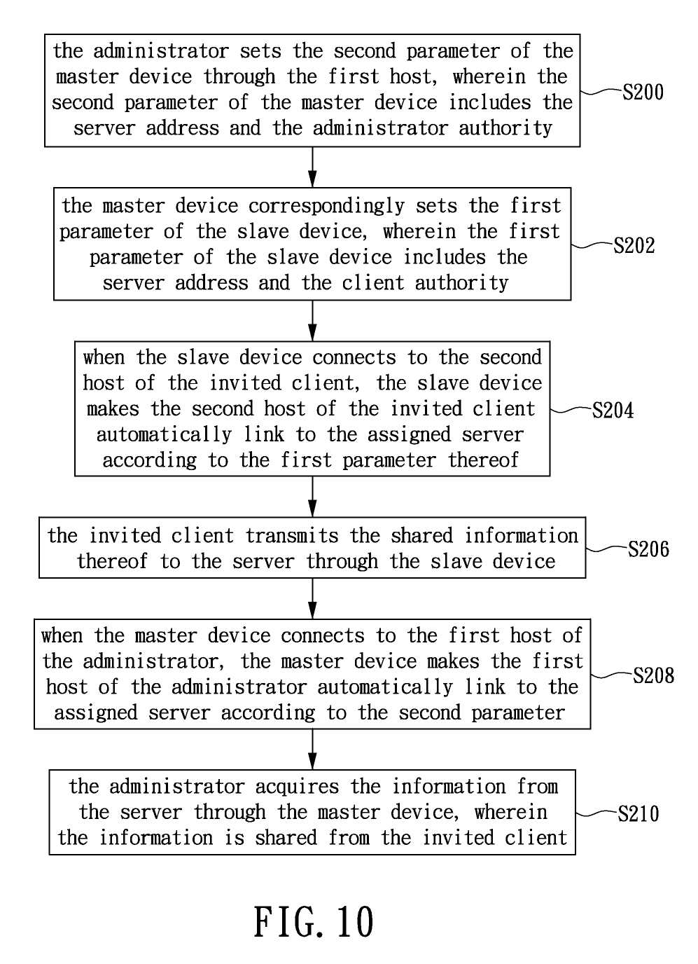

Please refer to FIG. 10 which shows a flow chart that the invited client shares the information thereof through the slave device according to an embodiment of the present disclosure. At step S200, the administrator 70 sets the second parameter of the master device 102 through the first host 100. The second parameter includes the server address of the server 104 and the administrator authority. Then, at step S202, the master device 102 correspondingly sets the first parameter of the slave device 110, and the first parameter includes the server address of the server 104 and the usage authority. At step S204, when the slave device 110 connects to the second host 108 of the invited client 76, the slave device 110 makes the second host 108 automatically link to the assigned server 104 according to the first parameter. After that, at step S206, the invited client 76 transmits the shared information to the server 104 through the slave device 110. Then, at step S208, when the master device 102 connects to the first host 100 of the administrator 70, the master device 102 makes the first host 100 automatically link to the server 104 according to the second parameter. At last, at step S210, the administrator 70 acquires the information from the server 104 through the master device 102, wherein the information is shared from the invited client 76. On the basis of the above, the slave device 110 shares the information shared from the invited client 76 to the administrator 70.

### Embodiment that Administrator and Invited Client Share Information through Peer-to-Peer Network Link

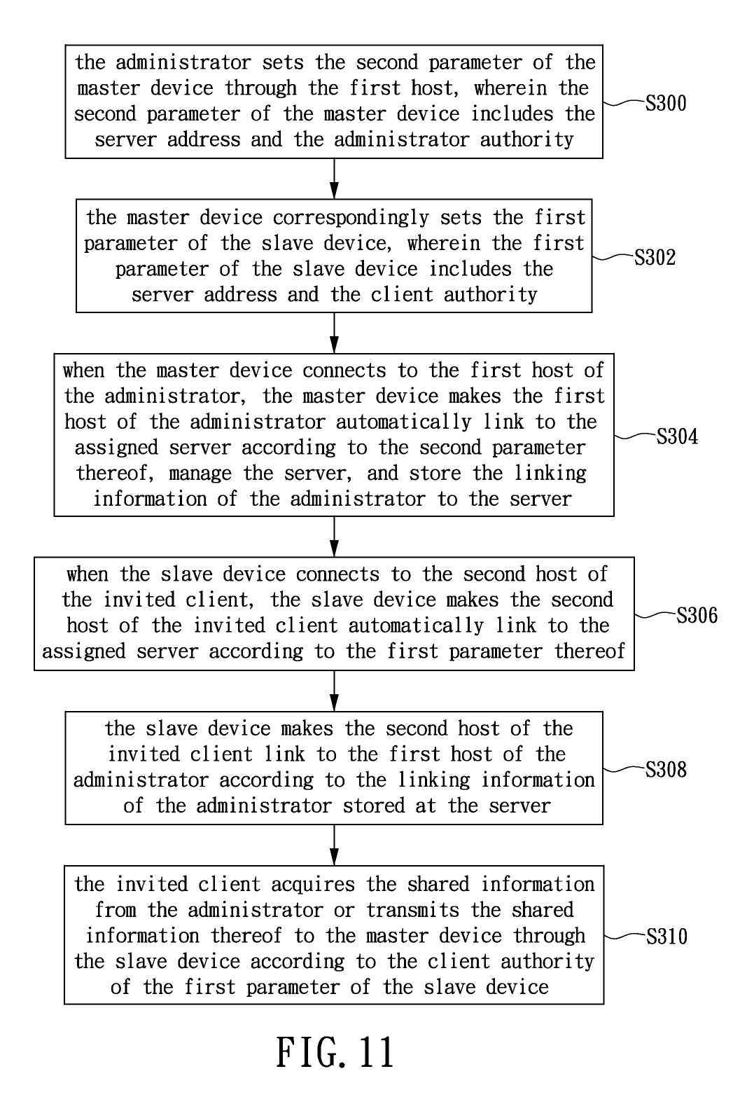

FIG. 11 shows a flow chart that the administrator and the invited client sharing information through a peer-to-peer network link according to an embodiment of the present disclosure. At step S300, the administrator 70 sets the second parameter of the master device 102 through the first host 100. The second parameter includes the server address of the server 104 and the administrator authority. Then, at step S302, the master device 102 correspondingly sets the first parameter of the slave device 110. The first parameter includes the server address of the server 104 and the client authority.

At step S304, when the master device 102 connects to the first host 100 of the administrator 70, the master device 102 makes the first host 100 automatically link to the server 104 according to the second parameter, and manage the server 104, and store the linking information of the administrator 70 to the server 104. Then, at step S306, when the slave device 110 connects to the second host 108 of the invited client 76, the slave device 110 makes the second host 108 automatically link to the server 104 according to the first parameter, and store the connection information of the invited client 76 to the server 104. At step S308, according to the linking information of the administrator 70 stored in the server 104, the slave device 110 makes the second host 108 link to the first host 100, such that a peer-to-peer network link between the administrator 70 and the invited client 76 is established. On the other hand, according to the linking information of the invited client 76 stored in the server 104, the master device 102 makes the first host 100 link to the second host 108, such that the peer-to-peer network link between the administrator 70 and the invited client 76 is established. At last, at step S310, according to the client authority of the first parameter of the slave device 110, the invited client 76 acquires the shared information from the administrator 70, or transmits the shared information thereof to the master device 102 through the slave device 110.

What is claimed is:

1. An active information sharing system, comprising:
an administrator, comprising a master device and a first host, the master device is used to be connected to the first host through a first bus interface, wherein the first host sets a second parameter of the master device, the second parameter comprises a first server address and an administrator authority, and the master device automatically links to a server through a first network module of the first host according to the second parameter, for sharing at least a first information from the administrator; and
at least an invited client, comprising a slave device and a second host, when the slave device is connected to the master device through a second bus interface, the master device sets a first parameter by the master device, wherein the first parameter includes a second server address and a client authority;
when the slave device with the set first parameter is connected to the second host of the invited client through the second bus interface, the slave device automatically links to the server through a second network module of the second host according to the first parameter, for acquiring the first information.

2. The active information sharing system according to claim 1, wherein the master device has a female connector, when the master device connects to the slave device through the female connector, the master device correspondingly sets the first parameter of the slave device.

3. The active information sharing system according to claim 1, wherein when the master device and the slave device respectively connects to the first host through the first and second bus interfaces, the master device is connected to the slave device through the first host, and the master device correspondingly sets the first parameter of the slave device.

4. The active information sharing system according to claim 1, wherein the invited client shares at least a second information of the invited client through the slave device.

5. The active information sharing system according to claim 1, wherein the master device correspondingly sets the first parameter of the slave device through the server.

6. The active information sharing system according to claim 1, wherein when the master device links to the server through the first host, a first linking information of the first host is stored to the server, and when the slave device links to the server through the second host, a second linking information of the second host is stored to the server;
thus when both of the master device and the slave device link to the server, the master device and the slave device are linked to with each other according to the first and second linking informations, and the administrator and the invited client linked to each other in a peer-to-peer network link.

7. A master device connected to a first host of an administrator or a slave device of an invited client through a bus interface, comprising:
an active device connected to the first host of the administrator, used to set a second parameter to the master device through the first host, wherein the second parameter includes a second server address and a administrator authority, and the active device automatically links to a server through a first network module of the first host according to the second parameter, for sharing at least a first information from the administrator; and
an extended logic unit for correspondingly setting a first parameter of the slave device, wherein the first parameter includes a first server address and a client authority.

8. The master device according to claim 7, wherein the active device comprises:
a control unit connected to the first network module of the first host, and generates a control command;
a logic unit connected to the control unit, used to receive the control command, and to generate an operation command;
a storage unit connected to the logic unit, used to receive the operation command for executing a storage operation; and
an emulation unit, used to make the master device automatically link to a server by executing an application program.

9. The master device according to claim 7, wherein when the master device links to a server through the first host, a linking information of the first host is stored to the server.

10. The master device according to claim 7, further comprising:
a female connector, wherein the master device is connected to the slave device through the female connector, such that the extended logic unit correspondingly sets the first parameter of the slave device.

11. A slave device connected to a master device of a administrator, a first host, or a second host of an invited client through a bus interface, comprising:
a connection managing unit connected to the master device, the first host, or the second host; and
an active device, used to allow the master device of the administrator to correspondingly set a first parameter to the slave device, wherein the first parameter includes a server address and client authority, and the active device automatically links to a server through a second network module of the second host according to the first parameter, for acquiring at least a first information shared from the administrator.

12. The slave device according to claim 11, wherein the active device includes:
a control unit connected to the second network module of the second host, used to generate a control command;
a logic unit connected to the control unit, for receiving the control command and generating an operation command;
a storage unit connected to the logic unit, for receiving the operation command for executing a storage operation; and
an emulation unit, used to make the slave device automatically link to a server by executing an application program.

13. The slave device according to claim 11, wherein when the slave device links to the server through the second host, a linking information of the second host is stored to the server.
